(19) United States
(12) Patent Application Publication
(10) Pub. No.: US 2009/0232140 A1
(43) Pub. Date: Sep. 17, 2009

(54) PACKET TRANSMISSION APPARATUS AND METHOD

(76) Inventors: Hiroyuki KITAJIMA, Kawaski (JP); Hisaya Ogasawara, Osaka (JP); Atsushi Kitada, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/403,720

(22) Filed: Mar. 13, 2009

(30) Foreign Application Priority Data
Mar. 14, 2008 (JP) 2008-65430

(51) Int. Cl. H04L 12/56

(52) U.S. Cl. 370/394

(57) ABSTRACT

A packet transmission apparatus includes a transmission unit dividing input data and transferring segments, which are obtained by adding sequence numbers to the respective pieces of the divided data, a switch unit transferring the segments to one of a plurality of reception units, and a reception unit reconstructing an original input packet from the plurality of segments that arrive from the switch units on the basis of the sequence numbers. The reception unit includes a packet buffer storing segments that arrive from the switch units, a determination unit determining, on the basis of the sequence number, whether the segment stored in the packet buffer is to be discarded; and a discard part reading the segment stored in the packet buffer in an order from the segment having an older sequence number and discarding the segment that is determined to be discarded.

### CROSS-REFERENCE TO RELATED APPLICATIONS

This application is based upon and claims the benefit of priority of the prior Japanese Patent Application No. 2008-65430, filed on Mar. 14, 2008, the entire contents of which are incorporated herein by reference.

### BACKGROUND

1. Field

The embodiment(s) discussed herein are related to a technique for controlling packet data in a packet transmission apparatus.

2. Description of the Related Art

FIG. 1 is an example of the configuration of a typical packet transmission apparatus 1. The packet transmission apparatus 1 includes transmission units 2#1 to 2#N, switch units 3#1 to 3#N and reception units 4#1 to 4#N.

Each of the transmission units 2#1 to 2#N divides an individual input packet into pieces of data having substantially equal size, and then transmits the pieces of data (hereinafter referred to as segments) attached with a transmission unit number, a destination unit number and sequence numbers to a plurality of transmission paths at equal traffic while monitoring the status of each transmission path (load sharing).

Each of the switch units 3#1 to 3#N refers to a destination unit number attached to each segment, and executes a control to transmit the input segment to an intended one of the reception units 4#1 to 4#N (path switching).

Because of the above load sharing and path switching, a segment passes through an unspecified transmission path, so the order in which segments are sent is not sequential and thus when the segments arrive at the reception units 4#1 to 4#N the segments are not in sequence.

Each of the reception units 4#1 to 4#N sorts the segments that arrive nonsequentially, from the transmission units and in the transfer order to reconstruct the segments into an original packet.

FIG. 2 is a view that schematically depicts packet reconstruction in each of the reception units 4#1 to 4#N.

Each of the reception units 4#1 to 4#N stores segments, which are nonsequentially transferred from the plurality of transmission units 2#1 to 2#N, by transmission unit numbers (process P11), and sorts the stored segments on the basis of sequence numbers (process P12) to reconstruct the packets. Data are read from the buffers to output the packets (process P13).

In this case, when a state where input is larger than output continues in the reception units 4#1 to 4#N, segments accumulate in the corresponding buffers and then overflow. To prevent the overflow, it is conceivable that the storage space of the buffer is monitored by using transmission unit numbers and, if it is likely to overflow, segments are discarded in order from the oldest segment in the buffer.

In addition, for example, when an error occurs in a transmission path and, therefore, a segment that is on the path is eliminated, the reception units 4#1 to 4#N are not able to reconstruct the packet that includes the eliminated segment. Thus, segments are indefinitely left in the buffer, and it is conceivable that a reconstruction process malfunctions. To prevent this situation, it is conceivable that times at which segments arrive at the reception units 4#1 to 4#N are further added to the segments and stored in the corresponding buffers, retention times of the segments in the respective buffers are measured in addition to sorting, and then segments that have stayed for a certain period of time or longer are discarded.

FIG. 3 is a view that schematically depicts packet reconstruction in the reception units 4#1 to 4#N in consideration of the retention times. In FIG. 3, in comparison with FIG. 2, a timer is added and an arrival time is added to the segment to be written to the buffer in buffer writing control (process P21) and the storage spaces of the buffers are monitored (process P22). In addition, timeout processing is executed in sorting (process P23), and then a discard process is executed in buffer reading control (process P24).

Japanese Laid-open Patent Publication No. 2003-298601 describes a technique for avoiding an overflow in such a manner that the storage spaces of the buffers are monitored in a packet sorting unit.

### SUMMARY

According to an aspect of an embodiment, a packet transmission apparatus includes a transmission unit dividing input data and transferring segments, which are obtained by adding sequence numbers to respective pieces of the divided data, to any one of a plurality of switch units. A switch unit transferring the segments to any one of a plurality of reception units and a reception unit reconstructing an original input packet from the plurality of segments that arrive from the switch unit(s) on the basis of the sequence numbers, where a packet buffer stores segments that arrive from switch unit(s), a determination unit determines, on the basis of the sequence number, whether the segment stored in the packet buffer is to be discarded and a discard part reading the segment stored in the packet buffer in an order from a segment having an older sequence number and discarding the segment that is determined to be discarded.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an example of a configuration of a packet transmission apparatus.

FIG. 2 is a view that schematically depicts packet reconstruction in reception units.

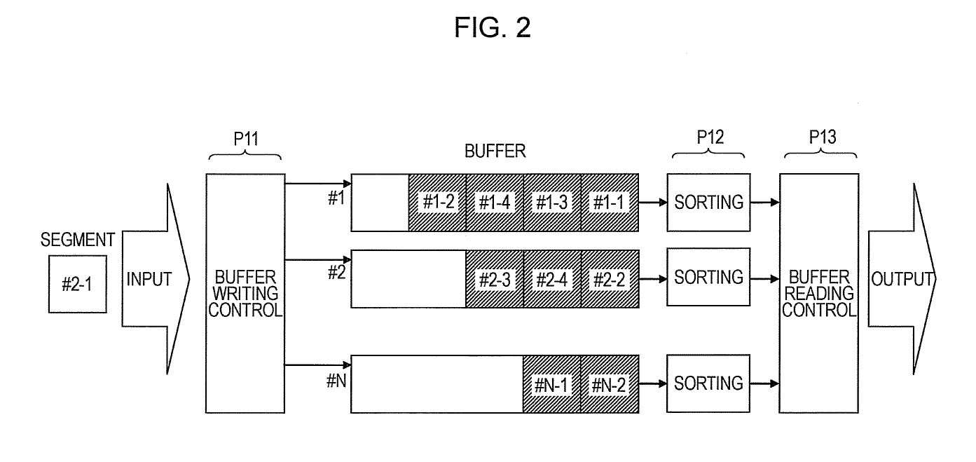

FIG. 3 is a view that schematically depicts packet reconstruction in reception units in consideration of retention times.

FIG. 4 is an example of dividing a packet into segments.

FIG. 5 is an example of a structure of a segment.

FIG. 6 is an example of a configuration of a reception unit.

FIG. 7 is an example of a configuration of a packet reconstruction unit.

FIG. 8 is an example of a configuration of a sorting unit.

FIG. 9 is an example flowchart of a process executed in a reordering unit.

FIG. 10 is an example of a status of a reorder buffer.

FIG. 11 is an example flowchart of a process executed in a patrolling unit.

FIG. 12 is an example flowchart of a process executed in a reassembling unit.

FIG. 13 is an example flowchart of a process executed in a transfer unit.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

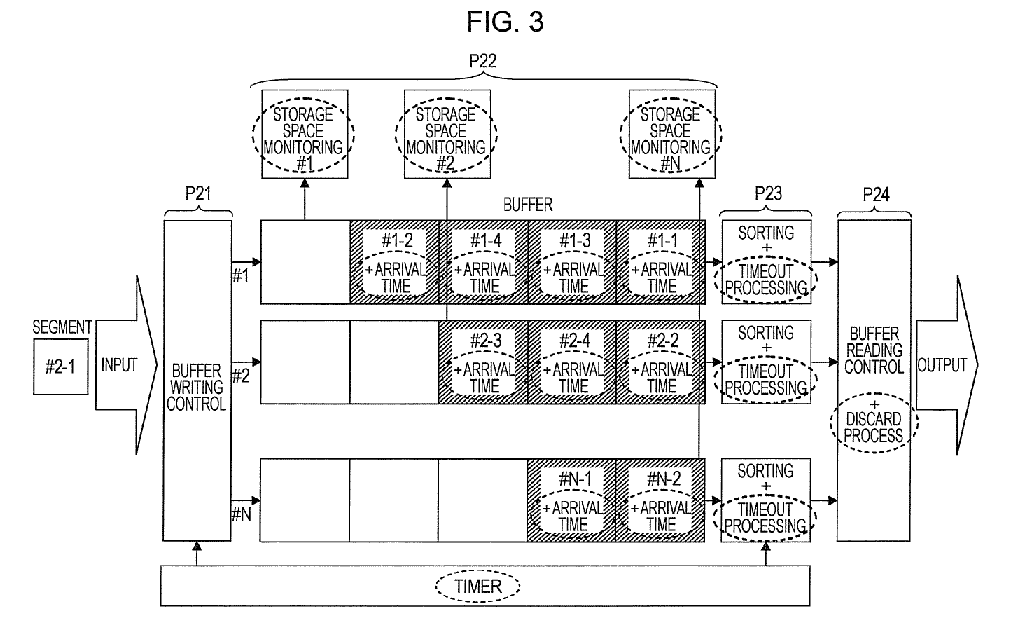

The above described method depicted in FIG. 3 is able to prevent a situation that segments are indefinitely left in a buffer in consideration of retention times of the segments; however, it requires the function of monitoring storage spaces by transmission unit numbers, the function of writing arrival times in buffers on the basis of a timer, and a timeout processing function. This problematically increases the circuit size.

Hereinafter, a preferred embodiment will be described.

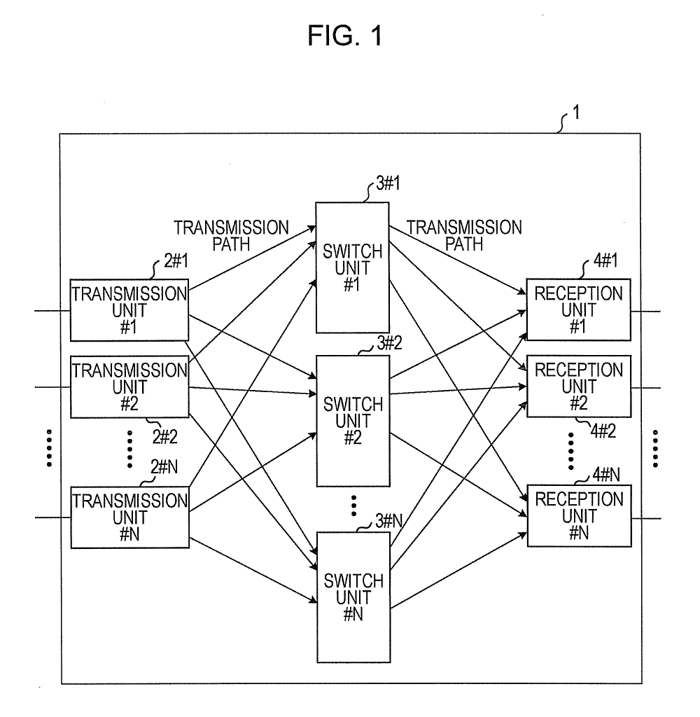

A packet transmission apparatus 1 according to one embodiment may have a similar configuration to that depicted in FIG. 1 in a higher level. That is, the packet transmission apparatus 1 includes transmission units 2#1 to 2#N, switch units 3#1 to 3#N and reception units 4#1 to 4#N. Portions of the reception units 4#1 to 4#N are functionally different, and the detail of the difference will be described later.

First, the transmission units 2#1 to 2#N depicted in FIG. 1 divide individual input packets into pieces of data having substantially equal size and generate segments having transmission (source) unit numbers, destination (reception) unit numbers and sequence numbers. Hereinafter, in the present embodiment, the segment is such that an input packet is divided and then headers are respectively added to the divided packets.

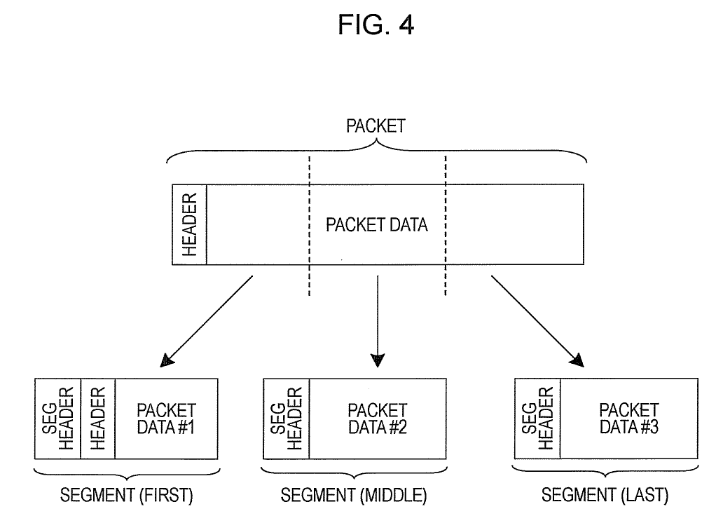

FIG. 4 is an example of dividing a packet into segments.

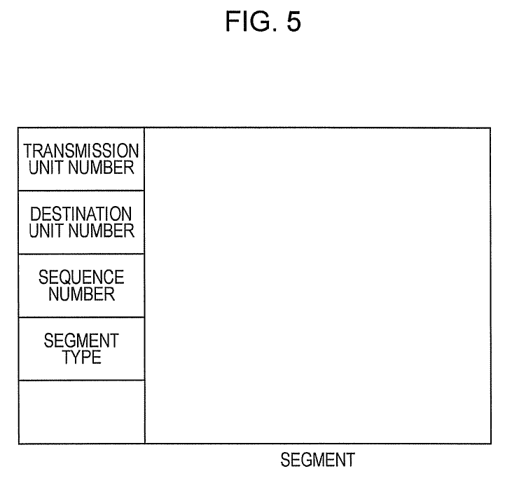

FIG. 5 is an example of a structure of a segment.

In FIG. 4, the input packet is formed of a packet header and packet data. The input packet is divided, for example, to have a predetermined size. In addition, a segment header is assigned to each of the divided packets.

As depicted in FIG. 5, the segment headers each include a transmission unit number, a destination unit number, a sequence number, a segment type, and the like.

The transmission unit number is a unit number (or a source unit identifier) of any one of the transmission units 2#1 to 2#N, which is a transmission source of the segment, and is used to identify from which transmission unit (2#1 to 2#N) the segment is transmitted when sorting in each of the reception units 4#1 to 4#N.

The destination unit number is a destination, that is, a destination unit number (or a destination unit identifier) of any one of the reception units 4#1 to 4#N, and is used to switch a path in each of the switch units 3#1 to 3#N.

The sequence number is a number assigned sequentially segment by segment, and is used for sorting in each of the reception units 4#1 to 4#N.

The segment type indicates the type of a segment and, for example, indicates a segment order such as a first segment, a middle segment, or a last segment, among the segments divided as depicted in FIG. 4.

Referring back to FIG. 1, each of the transmission units 2#1 to 2#N transmits segments generated as described above to a plurality of transmission paths at equal traffic while monitoring the status of each of the transmission paths (load sharing).

Subsequently, each of the switch units 3#1 to 3#N refers to the destination unit number attached to a segment, and executes a control to transmit the input segment to the intended one of the reception units 4#1 to 4#N (path switching).

Because of the above load sharing and path switching, a segment passes through an unspecified transmission path, so the order of segments may be not sequential when the segments arrive at the reception units 4#1 to 4#N.

Each of the reception units 4#1 to 4#N sorts the segments, arrived nonsequentially, by transmission units and in the transfer order to reconstruct the segments into an original packet.

Hereinafter, the internal configuration and operation of each of the reception units 4#1 to 4#N will be described.

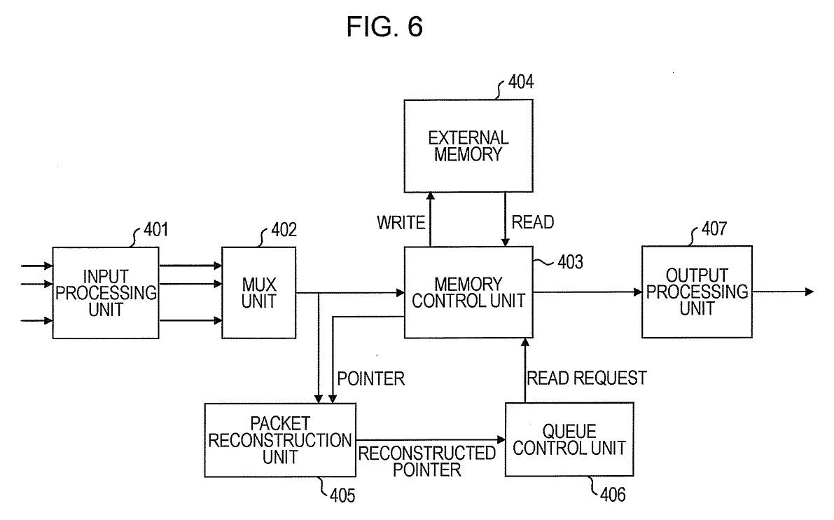

FIG. 6 is an example of a configuration of each of the reception units 4#1 to 4#N.

Each of the reception units 4#1 to 4#N includes an input processing unit 401, an MUX (MUltipleXer) unit 402, a memory control unit 403, an external memory 404, a packet reconstruction unit 405, a queue control unit 406 and an output processing unit 407.

The input processing unit 401 receives segments, input from the switch units 3#1 to 3#N intended to any one of the reception units 4#1 to 4#N, by transmission paths.

The MUX unit 402 multiplexes a plurality of segments, received in the input processing unit 401, into one segment.

The memory control unit 403 writes the segment multiplexed in the MUX unit 402 to the external memory 404 as multiplexed segments. In addition, when a read request is input from the queue control unit 406, data of the corresponding address are read from the external memory 404. In addition, the address information (hereinafter, referred to as pointer) generated at a time of writing is transferred to the packet reconstruction unit 405.

The packet reconstruction unit 405 extracts information, such as the sequence number and the transmission unit number, added to the segments, and sorts the segments together with the pointers received from the memory control unit 403 to reconstruct an original packet data row.

The queue control unit 406 receives the pointers that are sorted in an order according to, for example, a packet row by the packet reconstruction unit 405, and schedules an order of reading data packet by packet by referring to the type of pointer, or the like. The readable pointers are output to the memory control unit 403 as a read request.

The output processing unit 407 transmits packet data received from the memory control unit 403.

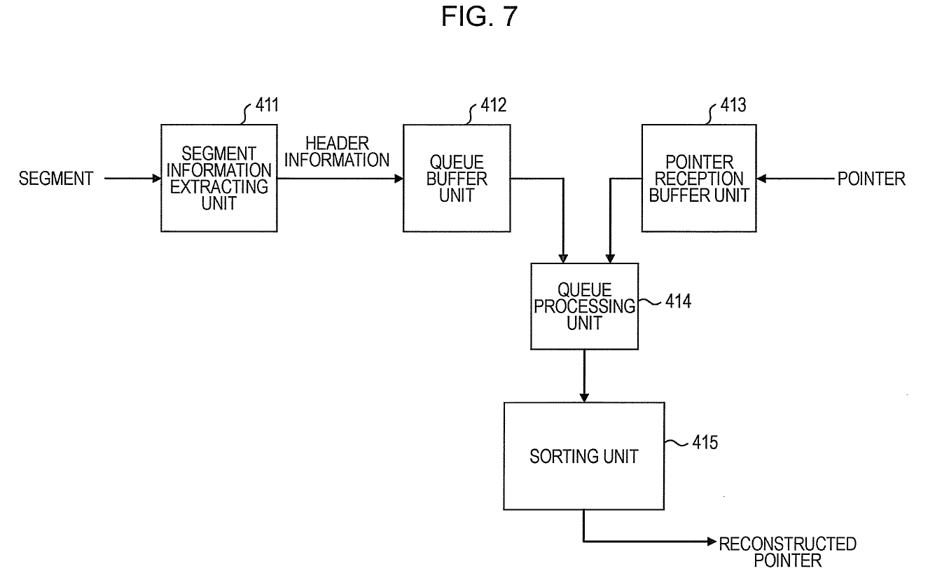

FIG. 7 is an example of a configuration of the packet reconstruction unit 405.

The packet reconstruction unit 405 includes a segment information extracting unit 411, a queue buffer unit 412, a pointer reception buffer unit 413, a queue processing unit 414 and a sorting unit 415.

The segment information extracting unit 411 extracts information such as the transmission unit number, destination unit number, sequence number, segment type, and the like, added in each of the transmission units 2#1 to 2#N.

The queue buffer unit 412 temporarily stores the information extracted by the segment information extracting unit 411 in an internal buffer.

The pointer reception buffer unit 413 temporarily stores the pointers received from the memory control unit 403 in an internal buffer.

The queue processing unit 414 determines whether the information and the pointers have been written to the queue buffer unit 412 and the pointer reception buffer unit 413, reads the information written at the same time from both buffer units, and then transfers the information to the sorting unit 415.

The sorting unit 415 sorts the pointers into an original order by packets on the basis of the information received from the queue processing unit 414, and outputs the reconstructed pointers.

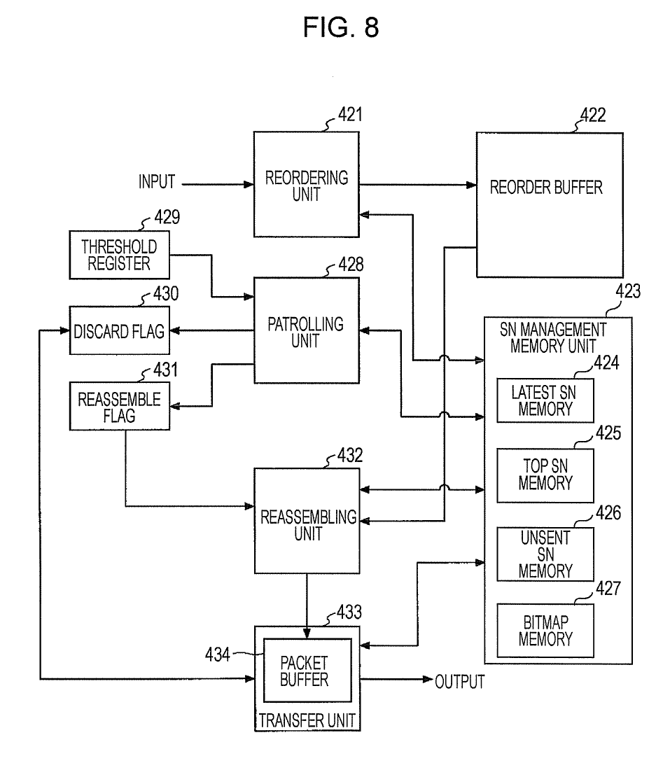

FIG. 8 is an example of a configuration of the sorting unit 415.

The sorting unit 415 includes a reordering unit 421, a reorder buffer 422, an SN (Sequence Number) management memory unit 423, a patrolling unit 428, a threshold register 429, a discard flag 430, a reassemble flag 431, a reassembling unit 432 and a transfer unit 433. The transfer unit 433 has a packet buffer 434.

The SN management memory unit 423 has a latest SN memory 424, a top SN memory 425, an unsent SN memory 426 and a bitmap memory 427. The latest SN memory 424 stores a segment having a largest sequence number value among arrived segments. The top SN memory 425 stores a sequence number value of a segment that is currently being sorted. The unsent SN memory 426 stores a sequence number value of a segment that is currently being transferred. The bitmap memory 427 indicates a current status of segments stored in the reorder buffer 422.

Hereinafter, the process of the sorting unit 415 will be described focusing on the process(es) of the reordering unit 421, patrolling unit 428, reassembling unit 432 and transfer unit 433.

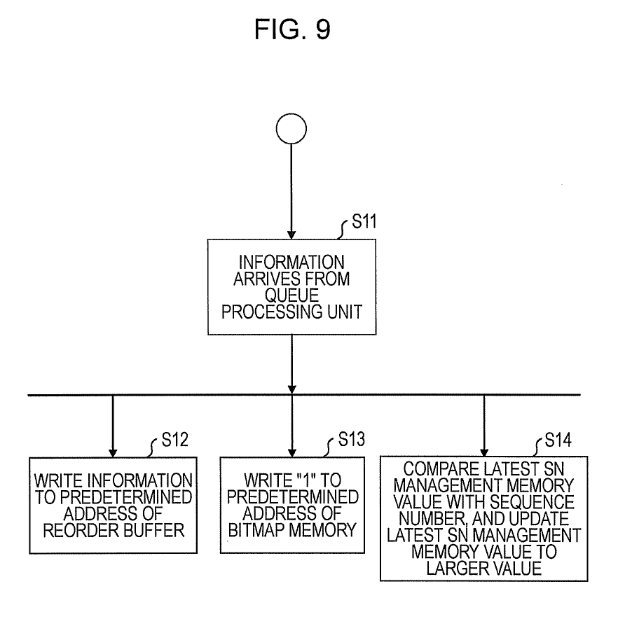

FIG. 9 is an example of a flowchart of a process executed in the reordering unit 421.

The reordering unit 421, when information arrives from the queue processing unit 414 (S11), stores the transferred information, for example, in a predetermined location of the reorder buffer 422 (S12). At this time, the storage location is determined on the basis of the transmission unit number and the sequence number.

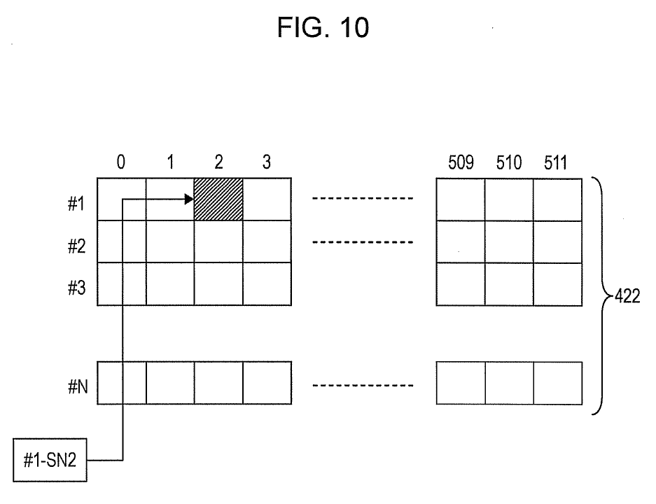

FIG. 10 is an example of a status of the reorder buffer 422. The reorder buffer 422 is configured as a ring buffer, and it is assumed that, in FIG. 10, the reorder buffer 422 is given addresses of 0, 1, 2, . . . , 511. The space of the reorder buffer 422 is partitioned by transmission unit numbers. If the segment having the transmission unit number=1 and the sequence number=2, for example, arrives, the segment is stored in a location indicated by shading in FIG. 10.

Referring back to FIG. 9, the reordering unit 421, at the same time of operation S12, writes “1” to the corresponding location of the bitmap memory 427 in the SN management memory unit (S13). The address space in the bitmap memory 427 is configured similarly to that of FIG. 10.

In addition, the reordering unit 421, at substantially the same time as operation S12, compares a value of the latest SN memory 424 in the SN management memory unit 423 with a sequence number of an arrived segment (received segment), and stores a larger value in the latest SN memory 424 (S14).

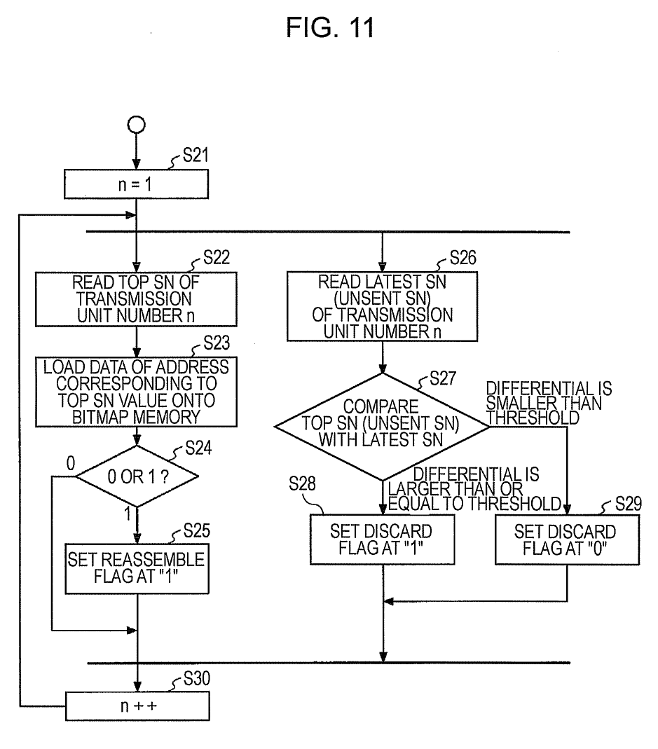

FIG. 11 is an example of a flowchart of a process executed by the patrolling unit 428.

The patrolling unit 428 first sets a variable n at “1”.

Subsequently, the patrolling unit 428, for example, reads the value (top SN) of the top SN memory 425, corresponding to the transmission unit number n from the SN management memory unit 423 (S22). Then, the patrolling unit 428 loads, for example, data of the address corresponding to the value stored in the top SN memory 425 onto the bitmap memory 427 in the SN management memory unit 423 (S23). Then, the patrolling unit 428 evaluates that value (S24) and, when the value is “1”, sets the reassemble flag 431 at “1” (S25). Note that the reassemble flag 431 is prepared by transmission unit numbers.

In addition, the patrolling unit 428 reads the value (latest SN) of the latest SN memory 424, corresponding to the transmission unit number n, from the SN management memory unit 423 (S26). Then, the patrolling unit 428 compares the top SN with the latest SN (S27) and, when a differential (which corresponds to the number of segments staying in the reorder buffer 422) is larger than or equal to a threshold, sets the discard flag 430 at “1” (S28). The threshold may be acquired from the threshold register 429, and the threshold register 429 may be externally set at a desired value.

Then, the patrolling unit 428, when the differential is smaller than the threshold, sets the discard flag 430 at “0” (S29).

Note that the case in which the latest SN is compared with the top SN is described; however, when the latest SN is compared with an unsent SN and the resulting differential is larger than or equal to a certain value, it may be regarded as a line congestion to thereby determine discarding.

After that, the patrolling unit 428, for example, adds 1 to the variable n (S30) and repeats the same processes (S22 to S29).

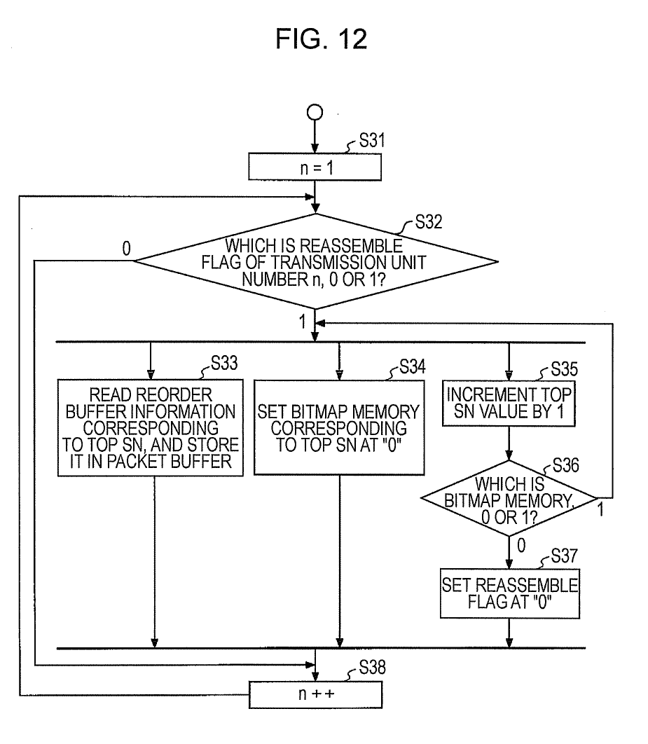

FIG. 12 is an example of a flowchart of a process executed by the reassembling unit 432.

The reassembling unit 432 first sets a variable n at “1” (S31).

Subsequently, the reassembling unit 432, for example, evaluates a reassemble flag corresponding to the transmission unit number n (S32). Then, the reassembling unit 432, when the reassemble flag 431 is “1”, reads the information corresponding to a value stored in the top SN memory 425 from the reorder buffer 422, and stores the information in the packet buffer 434 of the transfer unit 433 (S33).

In addition, the reassembling unit 432, for example, sets a corresponding bitmap memory 427 at “0” (S34).

In addition, the reassembling unit 432 adds 1 to the value of the top SN memory 425 (S35). Then, the reassembling unit 432 evaluates the value of the bitmap memory 427 (S36) and, when the value is “0”, sets the reassemble flag 431 at “0” (S37). In addition, the reassembling unit 432, when the value is “1”, repeats the processes (S33 to S37) in the case where the reassemble flag 431 is “1”.

After that, the reassembling unit 432 adds 1 to the variable n (S38) and repeats the same processes (S32 and the following operations).

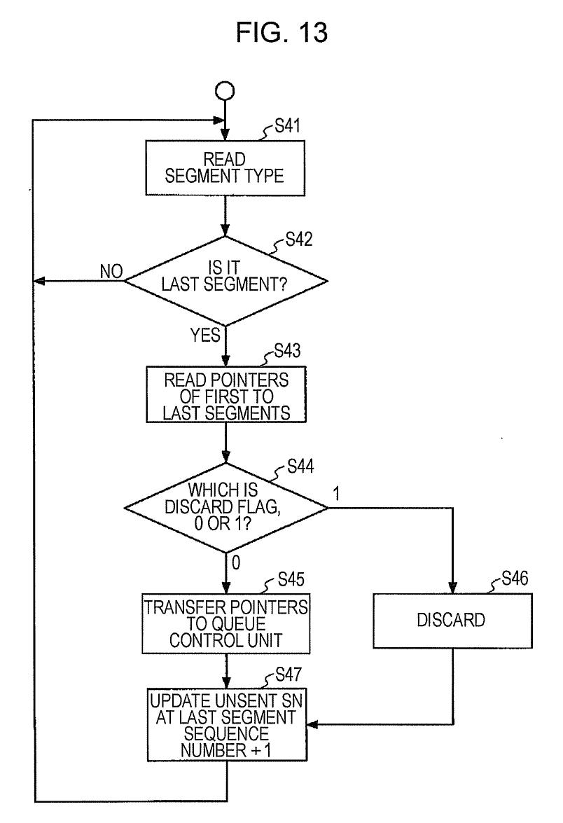

FIG. 13 is an example of a flowchart of a process executed by the transfer unit 433.

The transfer unit 433 reads a segment type stored in, for example, the packet buffer 434 of the transfer unit 433 (S41), and determinates whether the segment type is a last segment (S42). When the segment type is not a last segment, the transfer unit 433 returns to the process of reading a segment type (S41).

The transfer unit 433, when determining that the segment type is a last segment, reads the pointers of the first segment to the last segment (S43).

Subsequently, the transfer unit 433, for example, evaluates the discard flag 430 (S44) and, when the discard flag is “0”, completes reconstruction of the packet and then transfers the packet to the subsequent queue control unit 406 (S45).

In addition, the transfer unit 433, when the discard flag is “1”, discards all the read pointers (S46).

After that, the transfer unit 433 updates the value of the unsent SN memory 426 to the value that is obtained by adding 1 to the sequence number of the last segment (S47), and returns to the process of reading a segment type (S41).

In this way, according to an embodiment, it is possible to provide a compact apparatus that implements a discard process without increasing a circuit size. Part or all of the operation(s) described herein may be implemented using hardware and/or software. Further, while particular component(s) or element(s) are illustrated herein, the present invention is not limited thereto.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although a few embodiment(s) of the present invention have been described in detail, it should be understood that the various changes, substitutions, and alterations could be made hereto without departing from the spirit and scope of the invention, the scope of which is defined in the claims and their equivalents.

What is claimed is:

1. A packet transmission apparatus, comprising:
a transmission unit dividing input data and transferring segments of the input data to any one of a plurality of switch units, the segments being obtained by adding sequence numbers to respective pieces of the divided input data;
a switch unit transferring the segments, from the transmission unit, to any one of a plurality of reception units; and
a reception unit reconstructing an original input packet from the plurality of segments that arrive from the plurality of switch units based on the sequence numbers,
wherein the reception unit includes:
a packet buffer storing segments that arrive from the switch unit(s);
a determination unit determining whether a segment stored in the packet buffer is to be discarded based on a corresponding sequence number; and
a discard part reading the segment stored in the packet buffer in an order from a segment having an older sequence number and discarding the segment that is determined to be discarded.

2. The packet transmission apparatus according to claim 1, wherein the determination unit determines discarding of a segment when a differential between a sequence number of an arrived segment and a sequence number indicating a point at which a sequence reconstruction process is executed is larger than or equal to a certain value.

3. The packet transmission apparatus according to claim 1, wherein the determination unit determines discarding of a segment when a differential between a sequence number of an arrived segment and an oldest sequence number in the packet buffer is larger than or equal to a certain value.

4. The packet transmission apparatus according to claim 2, wherein the reception unit includes a register that holds a discard determination threshold using which determination of whether the differential is larger than or equal to a certain value is executed, and
the discard determination threshold of the register may be changed.

5. A method of controlling a packet transmission apparatus s, comprising:
dividing an input packet by adding sequence numbers to respective pieces of the divided input packet;
transferring segments of the divided input packet to any of a plurality of switches, the divided data having sequence numbers added thereto;
switching a path and reconstructing an original input packet from the plurality of segments received based on the sequence numbers;
determining, based on a sequence number, whether a segment that arrives based on the switching and stored in a packet buffer is to be discarded; and
reading the segment stored in the packet buffer in an order starting from a segment having an older sequence number and discarding the segment that is determined to be discarded.

6. The method of controlling the packet transmission apparatus according to claim 5, wherein discarding of a segment is determined when a differential between a sequence number of an arrived segment and a sequence number indicating a point at which a sequence reconstruction process is executed is larger than or equal to a certain value.

7. The method of controlling the packet transmission apparatus according to claim 5, wherein discarding of a segment is determined when a differential between a sequence number of an arrived segment and an oldest sequence number in the packet buffer is larger than or equal to a certain value.

8. A computer implemented method of controlling packet transmission, comprising:
determining whether any of segments of a divided data packet in a storage buffer should be discarded when reconstructing the packet to an original form; and
discarding each segment having an older sequence number relative to a segment identified in said determining.
